(19) United States
(12) Patent Application Publication
(10) Pub. No.: US 2024/0401702 A1
(43) Pub. Date: Dec. 5, 2024

(54) RAIL ASSEMBLY, BOGIE, BOGIE WHEEL AND INFLATABLE SEAL ASSEMBLY

(71) Applicant: NATIONAL RESEARCH COUNCIL OF CANADA, Ottawa (CA)

(72) Inventors: David HALLIDAY, Maple Ridge (CA); Nathan LOEWEN, Coldstream (CA); Craig BRECKENRIDGE, Sorrento (CA); Walter BRZEZIK, Roberts Creek (CA); Mike GEDIG, Vancouver (CA); Colin VINCENT, Victoria (CA)

(21) Appl. No.: 18/699,174

(22) PCT Filed: Oct. 7, 2022
(86) PCT No.: PCT/CA2022/051489

§ 371 Date: Apr. 5, 2024

(30) Foreign Application Priority Data
Oct. 7, 2021 (CA) 3144017

(51) Int. Cl. F16J 15/46; B61F 5/50; E04B 7/16

(52) U.S. Cl. CPC F16J 15/46; B61F 5/50; E04B 7/163

(57) ABSTRACT

A rail assembly for use with a bogie wheel includes two rail segments having mating end segments abutting against each other, and joined by a connecting bolt that traverse the mating end segments. A bogie for use with a rail includes a support frame, a chassis movably attached to the support frame, and an elastomeric bearing disposed between and in bearing engagement with the support frame and the chassis, to limit movement of the chassis relative to the support frame. A bogie wheel includes a central hub adapted for direct mounting to a bogie chassis, a tread, and a bearing assembly permitting rotation of the tread relative to the hub. An inflatable seal assembly for sealing between a first member and a second member includes an inflatable bladder, a membrane attached to the first member, and a tension spring attached to the membrane to bias the membrane against the bladder.

### CROSS-REFERENCE TO RELATED APPLICATION

This application claims priority to and the benefit of Canadian patent application no. 3,144,017, filed on Oct. 7, 2021, the entire contents of which are incorporated by reference in this application, where permitted.

### FIELD OF THE DISCLOSURE

In general, this disclosure relates to building components and mechanisms for effecting movement of building parts. More particularly, in aspects, this disclosure relates to a rail assembly, a bogie, and a bogie wheel, as may be used to effect relative rotation of building parts, such as rotating parts of a large telescope enclosure. In other aspects, this disclosure relates to an inflatable seal assembly to seal between two building parts, such as moving parts of a large telescope enclosure.

### BACKGROUND OF THE DISCLOSURE

Astronomical observatories include telescope enclosures for large ground-based telescopes, which may have mirror apertures in excess of ten meters in diameter. The “calotte” design for a telescope enclosure has a domed cap that covers the telescope and defines an opening that exposes the telescope to the sky. A shutter is movable relative to the opening to selectively occlude the opening. The domed cap is rotatable relative to a fixed base to selectively adjust an azimuthal angle and altitudinal angle of the opening. This rotational movement can be effected by rolling translation of a circular rail attached to the cap relative to wheeled bogies fixed to a stationary part of the telescope enclosure, or alternatively rolling translation of movable bogies attached to the cap relative to a circular rail fixed to the stationary part of the telescope enclosure.

The circular rail is too large to be prefabricated and transported to the construction site. Instead, numerous arcuate rail segments are transported to the construction site, and joined together at the construction site. The rail segments can be joined by welds or by scarf joints. Welding at high elevation sites is challenging and can disrupt other construction activities. Fully-welded joints can be impractical and costly considering the size of the rail segments, whereas partially-welded joints may be more prone to fatigue-related cracking. A scarf joint requires the ends of the rail segments to be tapered so that they can be overlapped and bolted to a common substrate, but the tapered ends may be prone to cracking and spalling. Further, forming the scarf joint requires precise alignment of the rail segments, which can be practically difficult. Misalignment of the rail segments can result in gaps or other geometric imperfections of rail surfaces that contact the bogie wheels. These imperfections can induce vibrations, impacts, and forces on the rail, the bogies and the telescope enclosure as a whole, which are detrimental to their durability and serviceability. They are also detrimental to the telescope, which is sensitive to vibrations that may be transmitted from the enclosure through the ground to the telescope pier. Accordingly, there is a need in the art for alternative joints between the rail segments.

Bogie components (e.g. bearings and axle shafts) are prone to failure because of the large axial and radial loads applied to them by bogie wheels. Radial loads are primarily attributable to the weight of the structures, and in part to the wheels being canted inward toward the rotational axis to ‘steer’ the rail along a circular path. Axial loads are attributable to environmental loads (e.g. wind, thermal and seismic loads), the aforementioned inward cant of the wheels, as well as potential tangential and radial misalignment of the bogie wheels. In addition to inducing misalignment loads, misalignment of the bogie wheels can result in loss of positive rolling contact between the bogie wheels and the rails, interfere with smooth rolling of the rail along the bogies, damage rail and bogie components, and reduce their service life. Misalignment loads can be attributable to geometric imperfections of the rail (e.g. deviations from a perfect circular shape) due to practical fabrication and installation tolerances, and elastic deflections due to gravity, temperature changes and wind pressure. Accordingly, there is a need in the art for a bogie that avoids or reduces misalignment of the bogie wheels and ensures that the bogie wheels remain in rolling contact with the rail.

Bogies have wheels mounted on axle shafts, which are rotatably attached by bearings to the bogie chassis. As noted, the axle shafts are susceptible to damage. Further, the wheels are typically secured to axle shafts by interference fit. Ensuing proper interference fit of the wheels on the axle shafts during manufacturing of the bogie is costly and time-consuming. Improper interference fit renders the axle shaft even more susceptible to damage. Further still, the axle shaft itself is a non-trivial part of the overall cost of the bogie. Accordingly, there is a need in the art for a bogie that is less susceptible to damage, and more convenient and economical to manufacture.

Parts of the telescope enclosure, particularly moving parts, may be separated by gaps that are too large to be sealed by conventional sealing systems, and that may vary in size during operation of the telescope enclosure. Accordingly, seals between such parts may be instead be effected by seals that can be selectively inflated or deflated as necessary to fill the gap. Inflatable seals, however, are prone to damage and leakage. The seals are often difficult to access for inspection and repair, and leaks may be difficult to locate. Repairing leaks in rubber seals involves a vulcanization process, which is costly to complete in the field. One cause of rubber seal failure is adhesion between the seal and another moving part due to ice formation between their interfacing surfaces. Accordingly, there is a need in the art for an inflatable seal assembly that is less prone to damage, and the aforementioned ice formation phenomenon.

### SUMMARY OF THE INVENTION

In one aspect, the present invention comprises a rail assembly for use with a bogie having a bogie wheel. The rail assembly comprises an elongate first rail segment, an elongate second rail segment, and a connecting bolt. The first and second rail segments define complementarily shaped mating end surfaces in abutting relationship with each other. The first and second rail segments collectively define an elongate normal wheel contact surface defining a travel direction for the bogie wheel, a lateral direction parallel to the normal wheel contact surface and perpendicular to the travel direction, and a normal direction perpendicular to the normal wheel contact surface. The connecting bolt extends across the mating ends surfaces at a bolt angle that is oblique to the travel direction and the lateral direction. The connecting bolt comprises a connecting bolt head and a connecting bolt shaft attached to the connecting bolt head. The connecting bolt head is received in a connecting bolt counterbore hole defined by the first rail segment. The connecting bolt shaft extends into a connecting bolt bore that extends from the connecting bolt counterbore hole, through the first rail segment, and into the second rail segment. An externally threaded portion of the connecting bolt shaft mates with an internally threaded portion of the connecting bolt bore defined by the second rail segment.

In embodiments of the rail assembly, the connecting bolt is tensioned to apply a compressive preload to compress the first and second rail segments together.

The rail assembly of claim 2, wherein the mating end surfaces define a gap between them that is closed by application of the compressive preload.

In embodiments of the rail assembly, each of the mating end surfaces comprises an intermediate portion that extends at an end surface angle that is oblique to the travel direction and the lateral direction. In such embodiments of the rail assembly, each of the mating end surfaces may comprise a transition portion that connects the intermediate portion to a lateral surface of the rail segment. The transition portion has a rounded shape in a sectional plane defined by the travel direction and the lateral direction.

In embodiments of the rail assembly, the end mating surface has a sigmoid shape in the sectional plane defined by the travel direction and the lateral direction.

In embodiments of the rail assembly, the rail assembly further comprises a key member, wherein the mating end surfaces collectively define a pocket that retains the key member to interfere with relative movement between the first and second rail segments.

In embodiments of the rail assembly, the rail assembly further comprises a plug that is received in the connecting bolt counterbore hole to cover the connecting bolt head. The plug may be flush with the lateral surface.

In embodiments of the rail assembly, the rail assembly further comprises a mounting bolt extending in the normal direction. The mounting bolt comprises a mounting bolt head received in a mounting bolt counterbore hole defined by either the first rail segment or the second rail segment. The mounting bolt also comprises a mounting bolt shaft attached to the mounting bolt head and extending through the rail segment and into an ancillary structure.

In embodiments of the rail assembly, the wheel contact surface is arcuate.

In another aspect, the present invention comprises a bogie for use with a rail that comprises an elongate normal wheel contact surface defining a travel direction for the bogie, a lateral direction parallel to the normal wheel contact surface and perpendicular to the travel direction, and a normal direction perpendicular to the normal wheel contact surface. The bogie comprises a support frame, a chassis, at least one normal wheel, and at least one elastomeric bearing. The chassis is movably attached to the support frame. The at least one normal wheel is rotatably mounted to the chassis to roll against the normal wheel contact surface about a rotation axis that extends in the lateral direction. The at least one elastomeric bearing is disposed between and in bearing engagement with the support frame and the chassis, to limit movement of the chassis relative to the support frame.

In embodiments of the bogie, the chassis is movably attached to the support frame to permit the chassis to rotate relative to the support frame, about an axis parallel to the normal direction, or about an axis parallel to the travel direction, or about an axis parallel to the lateral direction, or a combination of any two or more of such axes.

In embodiments of the bogie, the chassis is movably attached to the support frame to permit the chassis to translate relative to support frame, in the normal direction, or in the lateral direction, or in the lateral direction, or a combination of any two more of such directions.

In embodiments of the bogie, the at least one elastomeric bearing comprises an elastomeric lateral linear bearing, disposed between and in bearing engagement with the support frame and the chassis, to limit movement of the chassis relative to the support frame in the lateral direction. In such embodiments, the support frame may define a support frame bearing surface that is perpendicular to the lateral direction, and the chassis may define a chassis bearing surface that is perpendicular to the lateral direction. The elastomeric lateral linear bearing may be disposed between and in bearing engagement with the support frame and the chassis by contact with the support frame bearing surface and the chassis bearing surface that are perpendicular to the lateral direction.

In embodiments of the bogie, the at least one elastomeric bearing comprises an elastomeric normal linear bearing, disposed between and in bearing engagement with the support frame and the chassis, to limit movement of the chassis relative to the support frame in the normal direction. In such embodiments, the support frame may define a support frame bearing surface that is perpendicular to the normal direction, and the chassis may define a chassis bearing surface that is perpendicular to the normal direction. The elastomeric normal linear bearing may be disposed between and in bearing engagement with the support frame and the chassis by contact with the support frame bearing surface and the chassis bearing surface that are perpendicular to the normal direction.

In embodiments of the bogie, the at least one normal wheel comprises at least three normal wheels, wherein one of the normal wheels is offset from the other two normal wheels in the lateral direction.

In embodiments of the bogie, the bogie is for use with the rail that comprises a lateral wheel contact surface perpendicular to the lateral direction. In such embodiments, the bogie further comprises at least one lateral wheel rotatably mounted to the chassis to roll against the lateral wheel contact surface about a rotation axis that extends in the normal direction.

In another aspect, the present invention includes a bogie wheel for mounting to a bogie chassis and rolling against a rail. The bogie wheel comprises a central hub, a tread, and a bearing assembly. The hub defines an axial direction, and is adapted for direct mounting to the bogie chassis. The tread comprises a tread outer surface for rolling against the rail. The bearing assembly comprises an inner bearing race attached to the hub, an outer bearing race attached to the tread, and a plurality of roller bearings disposed between and distributed along the races to permit rotation of the outer bearing race and the attached tread relative to the inner bearing race and the attached hub.

In embodiments of the bogie wheel, the hub is adapted for directly mounting to the bogie chassis by defining a plurality of mounting bolt holes.

In embodiments of the bogie wheel, the roller bearings comprise tapered roller bearings.

In embodiments of the bogie wheel, the hub is a split hub that comprises an inner hub portion and an axially outer hub portion. The inner hub portion defines an inner hub portion radial shoulder. The outer hub portion defines an outer hub portion radial shoulder. A mounting bolt extends through a mounting hole defined collectively by the outer hub portion and the inner hub portion to axially compress the outer hub portion against the inner hub portion. As a result, the inner hub portion radial shoulder and the outer hub portion radial shoulder clamp against the inner bearing race to attach the inner bearing race to the hub.

In embodiments of the bogie wheel, the tread defines a tread radial shoulder. The tread is attached to the outer bearing race by a clamping ring bolted to the tread and axially compressing the outer bearing race against the tread radial shoulder.

In another aspect, the present invention comprises an inflatable seal assembly for sealing between a first member and a second member. The inflatable seal assembly comprises an inflatable bladder and a membrane. The membrane extends from a membrane first end to a membrane second end. The membrane first end is fixedly attached to the first member. The membrane is disposed between the bladder and the second member such that, in use, inflation of the bladder urges the membrane into contact with the second member or a part to the second member.

In embodiments of the inflatable seal assembly, the inflatable seal assembly further comprises a tension spring attached to and extending between the membrane second end and to the first member or to a third member attached to the member. The tension spring is oriented to bias the membrane against the bladder.

In embodiments of the inflatable seal assembly, the inflatable seal assembly further comprises the third member. The third member may comprise a gutter.

In embodiments of the inflatable seal assembly, the inflatable seal assembly further comprises the part attached to the second member, wherein the part attached to the second member comprises an elastomeric guard member.

In embodiments of the inflatable seal assembly, the membrane is made of a rubber. The rubber may comprise chlorosulphonated polyethylene synthetic rubber.

In embodiments of the inflatable seal assembly, the bladder comprises multiple compartments.

The rail assembly of the present invention may be combined with the bogie of the present invention to form a system. The bogie of the present invention may include the bogie wheel of the present invention. The rail assembly, the bogie, the bogie wheel, and the inflatable seal assembly of the present invention may be applied into a common structure.

### BRIEF DESCRIPTION OF THE DRAWINGS

The foregoing and other aspects of the disclosure will be better appreciated with reference to the attached drawings, as follows.

FIG. 1 is an exploded perspective view of an embodiment of a telescope enclosure that may include rail assemblies, bogies, and inflatable seal assemblies of the present disclosure.

FIG. 2 is a top perspective view of an embodiment of a system including pair of rail assemblies and a bogie of the present disclosure.

FIGS. 3 to 8 are views of an embodiment of one of the rail assemblies of the system of FIG. 2.

FIG. 3 is a top perspective view of the rail assembly.

FIG. 4 is a top perspective section view of the rail assembly along line IV-IV of FIG. 3.

FIG. 5 is another top perspective view of the rail assembly, from an perspective opposite to that of FIG. 2.

FIG. 6 is a magnified view of a portion of FIG. 5.

FIG. 7 is an exploded bottom perspective view of the rail assembly.

FIG. 8 is a top perspective view of the rail assembly attached to an ancillary structure in the form of a girder.

FIGS. 9 to 12 are views of an embodiment of the bogie of the system of FIG. 2.

FIG. 9 is a top perspective view of the bogie.

FIG. 10 is a top perspective exploded view of the bogie.

FIG. 11 is a bottom perspective view of the bogie.

FIG. 12 is a bottom perspective view of the bogie with the support frame thereof shown as transparent in dashed line.

FIGS. 13 to 15 are views of an embodiment of a wheel assembly of the bogie of FIG. 9.

FIG. 13 is an axial view of the wheel assembly.

FIG. 14 is a sectional view of the wheel assembly along line XIV-XIV of FIG. 13.

FIG. 15 is a perspective view of the wheel assembly along line XIV-XIV of FIG. 13.

FIGS. 16 and 17 are views of an embodiment of an inflatable seal assembly of the present disclosure, when sealing a gap between a pair of members, with one of the members and a gutter of the inflatable seal assembly shown as transparent in dashed line.

FIG. 16 is a perspective view of the seal assembly in an inflated state.

FIG. 17 is a perspective view of the seal assembly in a deflated state.

FIG. 18 is a view of a bladder of an inflatable seal assembly having multiple compartments.

### DETAILED DESCRIPTION OF EXAMPLE EMBODIMENTS

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order.

As used in this document, “each” refers to each member of a set or each member of a subset of a set. As used in this document, “attached” in describing the relationship between two connected parts includes the case in which the two connected parts are “directly attached” with the two connected parts being in contact with each other, and the case in which the connected parts are “indirectly attached” and not in contact with each other, but connected by one or more intervening other part(s) between.

The embodiments of the disclosures described herein are exemplary (e.g. in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. While the description contained herein constitutes a plurality of embodiments of the present disclosure, it will be appreciated that the present disclosure is susceptible to further modification and change without departing from the fair meaning of the accompanying claims. The scope of the invention, therefore, is only to be limited by the claims appended hereto and any amendments made thereto.

### General

In general, the disclosures herein relate to a rail assembly, a bogie, a wheel thereof, and an inflatable seal assembly that may be used as components of a building or other structure. A bogie is a chassis or a frame having wheels mounted rotatably thereon. Structures or objects maybe attached to the chassis or frame. In some uses, a rail rolls on the bogie wheels such that the rail and an attached structure or object moves relative to a stationary bogie. In other uses, the bogie wheels roll on a stationary rail such that a moving bogie moves relative to a stationary rail.

### Telescope Enclosure.

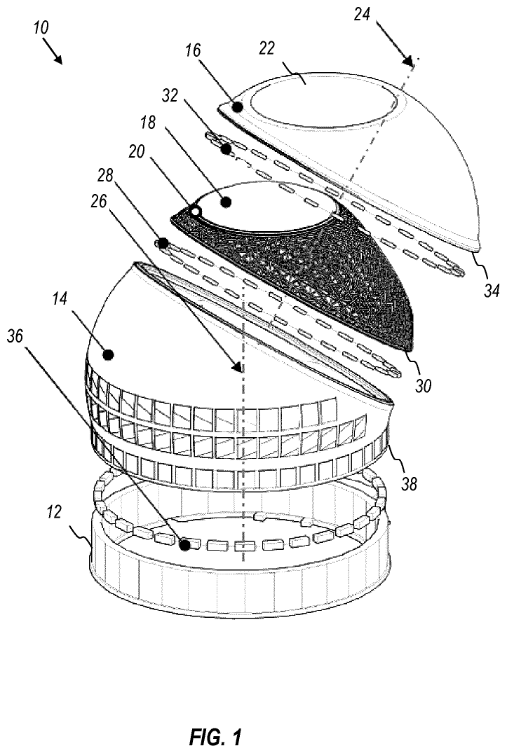

To illustrate an exemplary application of such components, reference is made to a calotte design telescope enclosure 10 shown in FIG. 1 for a large ground-based telescope (not shown), which may have a primary mirror diameter of about 30 meters or more. The telescope enclosure 10 includes a fixed base 12, a rotating base 14, a rotating domed cap 16 (also referred to as a calotte), a shutter 18, and an inflatable shutter seal 20. When the telescope enclosure 10 is in the closed configuration, a cap aperture 22 defined by the cap 16 is occluded by the shutter 18, and the inflatable shutter seal 20 is in its inflated state to seal a gap between the perimeter of the shutter 18, and the perimeter of the cap aperture 22. When it is desired to expose the telescope to the sky, the shutter seal 20 is deflated to accommodate relative movement between the shutter 18 and the cap 16. The shutter 18 is then rotated relative to the cap 16 until the cap aperture 22 is no longer occluded by the shutter 18. The cap 16 and shutter 18 are then rotated in unison relative to the rotating base 14 about a cap rotation axis 24 that is oriented at an oblique angle to the horizon. As the cap aperture 22 is offset from the cap rotation axis 24, rotation of the cap 16 about the cap rotation axis 24 varies an altitudinal angle of the cap aperture 22. The cap 16, shutter 18, and rotating base 14 are then rotated in unison relative to the fixed base 12 about a vertical base rotation axis 26 to vary the azimuthal angle of the cap aperture 22.

The rotation of the shutter 18 relative to the cap 16 is effected by wheeled shutter bogies 28 and an associated circular shutter rail 30. Similarly, the relative rotation of the cap 16 relative to the rotating base 14 is effected by wheeled cap bogies 32 and an associated circular cap rail 34. Similarly, the relative rotation of the rotating base 14 relative to the fixed base 12 is effected by wheeled base bogies 36 and an associated circular base rail 38. In one embodiment as shown, the bogies are fixed to a part that remains stationary during the rotation operation (e.g. the shutter bogies 28 and the cap bogies 32 are fixed to the rotating base 14, and the base bogies 36 are fixed to the fixed base 12), while the associated rail is fixed to a part that rotates during the rotation operation (e.g. the shutter rail 30 is fixed to the shutter 18, the cap rail 34 is fixed to the cap 16, and the base rail 38 is fixed to the rotating base 14), such that rotation of the rotating part is effected by rolling translation of the rail on the associated bogies, while the bogies remain stationary. In an alternative embodiment, the rail is fixed to the part that remains stationary, while the associated bogies are fixed to the part that rotates during the rotation operation, such that rotation of the rotating part is effected by rolling translation of the bogies on the associated rail, while the rail remains stationary.

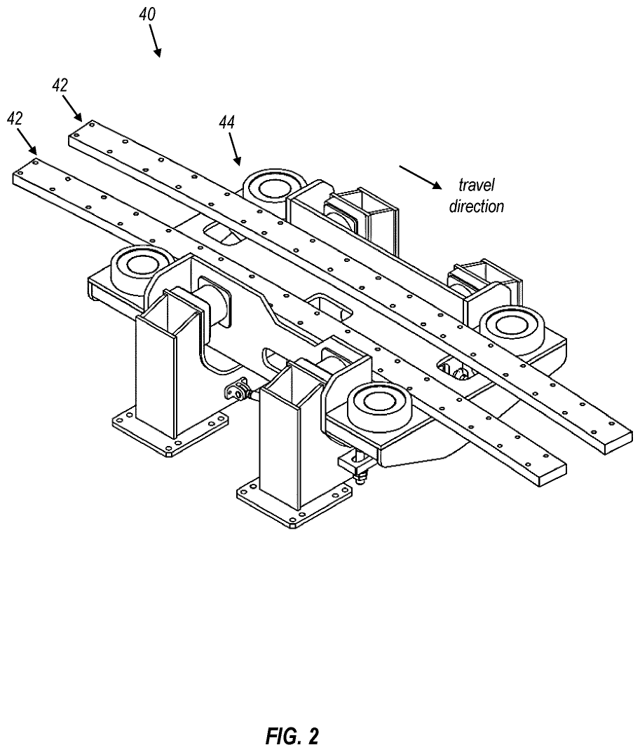

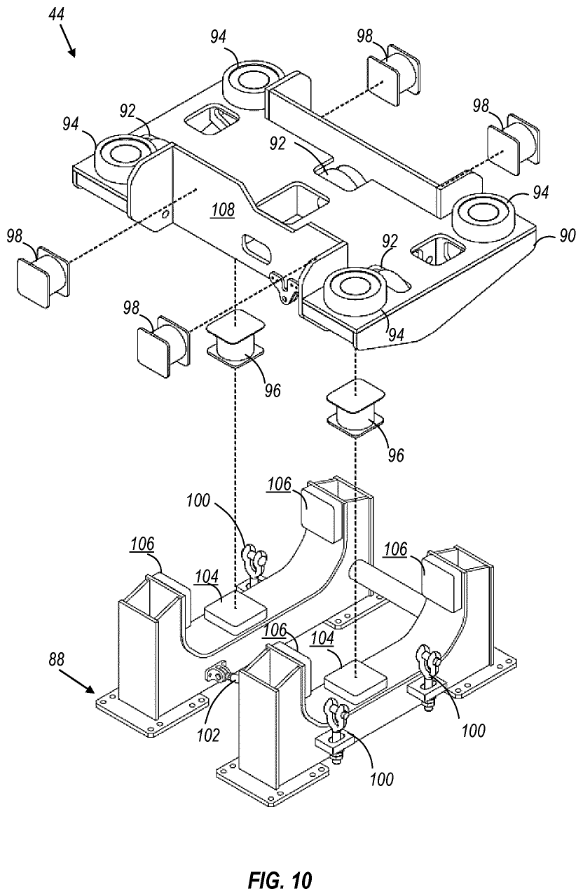

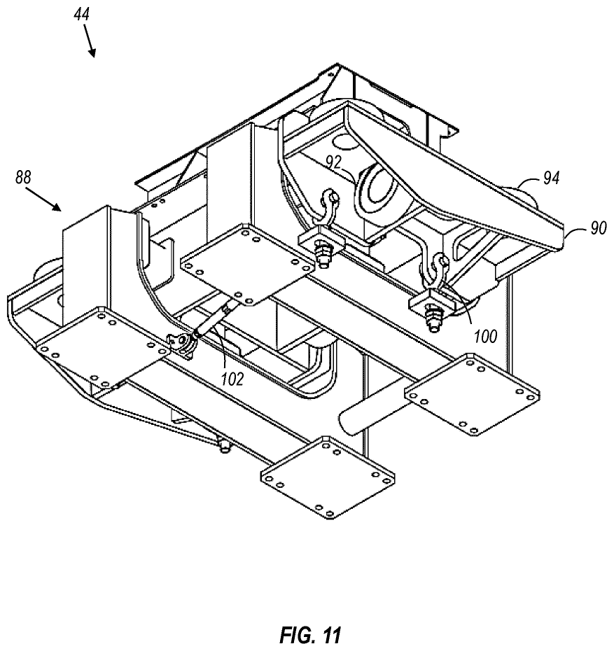

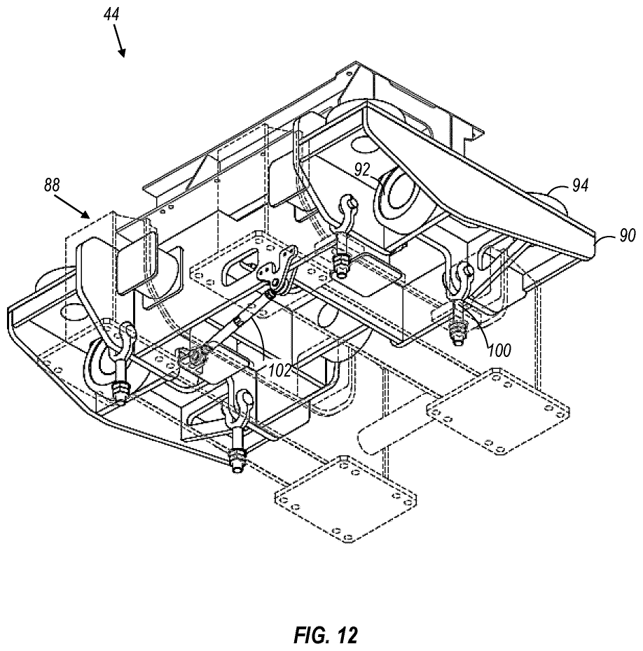

FIG. 2 shows a system 40 that includes a pair of rail assemblies 42 and a bogie 44 of the present disclosure. The shutter rail 30, cap rail 34 and base rail 38 may be implemented by the rail assembly 42 of the present disclosure, as further described below with reference to FIGS. 3 to 8. Having regard to the foregoing exemplary application these rails, it will be understood that the term “rail assembly” as used herein includes a rail that, in use, moves in relation to a stationary bogie 44, and a rail that, in use, is stationary in relation to a moving bogie 44. The shutter bogies 28, cap bogies 32, and base bogies 36 may be implemented by the bogie 44 of the present disclosure, as further described below with reference to FIGS. 10 to 16. Having regard to the foregoing exemplary application of these bogies, it will be understood that the term “bogie” as used herein includes a bogie that, in use, moves in relation to a stationary rail, and a bogie that, in use, is stationary in relation to a moving rail. It will be understood that the rail assembly 42 and bogie 44 of the present disclosure are not limited to use in a telescope enclosure 10, and may be used as components of other types buildings or structures. For example, the rail assembly 42 and bogie 44 may be useful for other types of buildings or structures such as stadia having rotating roofs, turntable assemblies for rotating platforms, and rotating cranes.

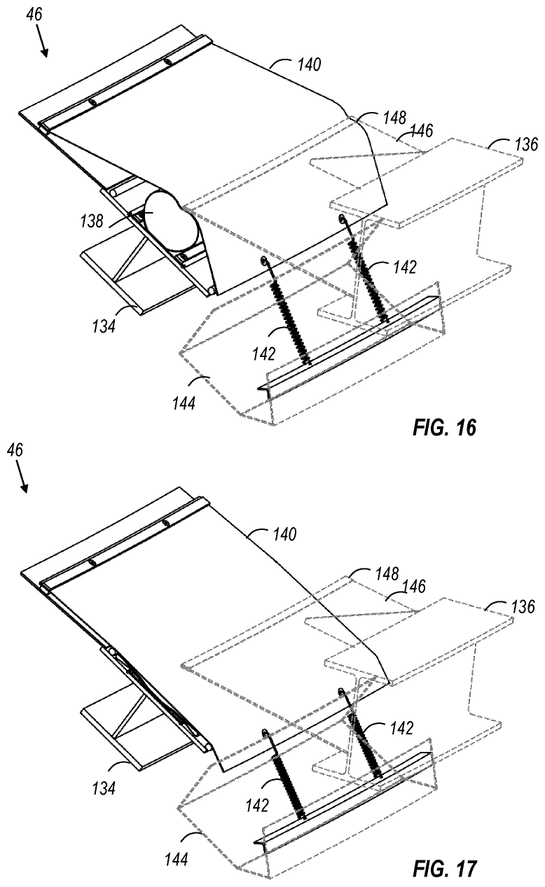

The inflatable shutter seal 20 may be implemented by the inflatable seal assembly 46 of the present disclosure as further described below with reference to FIGS. 16 and 17. It will be understood that the inflatable seal assembly 46 of the present disclosure is not limited to this use, and may be used to seal gaps between other building components. For example, the inflatable seal assembly 46 may be useful to seal large or variable-width gaps between doors, doors and door frames, and façade panels.

### Rail Assembly.

The purpose of the rail assembly 42 is to provide one or more contact surfaces that roll against a wheel of a bogie 44. In uses in which the bogie 44 is stationary and the rail assembly 42 moves relative to the bogie 44, the bogie 44 guides the movement of the rail assembly 42 along a travel direction as shown in FIG. 2. In uses in which the rail assembly 42 is stationary and the bogie 44 moves relative to the rail assembly 42, the rail assembly 42 guides the movement of the bogie 44 along the travel direction.

FIGS. 3 to 7 show views of the rail assembly 42 of FIG. 2 in isolation, and FIG. 8 shows a pair rail assemblies 42 attached to an ancillary structure in the form of a girder 48. In general, the illustrated embodiment of the rail assembly 42 includes a first rail segment 50, a second rail segment 52, connecting bolts 54, plugs 56, and mounting bolts 58. These components may be made of any material having suitable mechanical properties for an intended application, with a non-limiting example being structural strength steel.

Referring to the embodiment shown in FIG. 3, the first rail segment 50 and the second rail segment 52 collectively define an elongate normal wheel contact surface 60 for a bogie wheel. For spatial reference, the elongate normal wheel contact surface 60 defines a “travel direction” for the bogie wheel. The “lateral direction” is the direction parallel to the normal wheel contact surface 60, but perpendicular to the travel direction. The “normal direction” is the direction perpendicular to the normal wheel contact surface 60.

In this embodiment, the first rail segment 50 and second rail segment 52 have an elongate, substantially prismatic shape. Further, the first rail segment 50 and the second rail segment 52 are arcuate, so as to form part of a circular rail having a center (C). Accordingly, the travel direction corresponds to a tangential direction of the circular rail, whereas the lateral direction corresponds with one of the radii of the circular rail. In other embodiments, the first rail segment 50 and the second rail segment 52 may be straight or have different shapes.

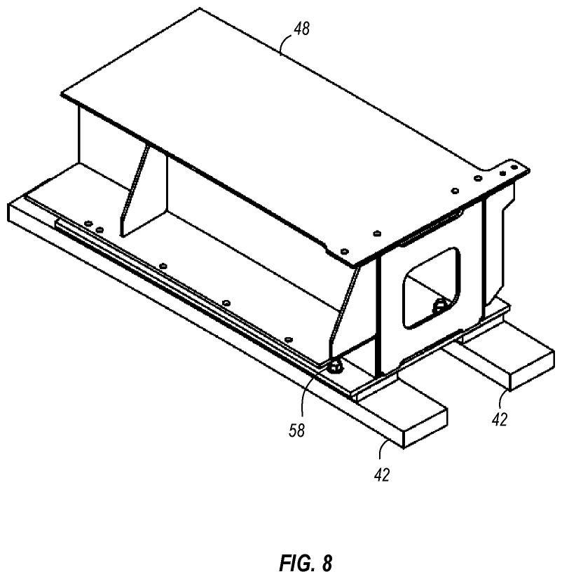

Referring to the exploded view of FIG. 7, the first rail segment 50 defines a mating end surface 62, and the second rail segment 52 defines a mating end surface 64 complementarily shaped to the mating end surface of the first rail segment 50. When the first rail segment 50 and second rail segment 52 are joined together to form the rail assembly 42, the mating end surfaces 62, 64 are in abutting relationship with other as shown in FIG. 3.

Referring to the exploded view of FIG. 7, in this embodiment, the mating end surfaces 62, 64 have a sigmoid shape in a sectional plane defined by the travel direction and the lateral direction. The sigmoid shape advantageously avoids sharp cusps at the ends of the rail segment, which may be weak and prone to damage. The mating end surfaces 62, 64 include an intermediate portion 66 and transition portions 68 that connect the intermediate portion 66 to the lateral surfaces 70 of the rail segments 50, 52. The intermediate portion 66 extends at an end surface angle that is oblique to the travel direction and the lateral direction. As used herein, “oblique” refers to a non-zero angle that is less than 90 degrees. In embodiments, the end surface angle may be between 30 degrees to 60 degrees relative to the travel direction. The transition portions 68 have a rounded shape in the sectional plane defined by the travel direction and the lateral direction.

Referring to the exploded view of FIG. 7, the mating end surfaces 62, 64 of the each define a pocket 72. When the mating end surfaces 62, 64 are abutted against each other, the pockets 72 are aligned with each other and together define a single pocket 72 that retains a key member 74. The key member 74 engages the portions of the mating end surfaces 62, 64 forming the pocket 72 to interfere with relative movement between the first rail segment 50 and the second rail segment 52. Preferably, the key member 74 prevents relative moment between the first rail segment 50 and the second rail segment 52 in the normal direction. Contact between the mating end surfaces prevents relative movement between the first rail segment 50 and the second rail segment 52 in the lateral and travel directions.

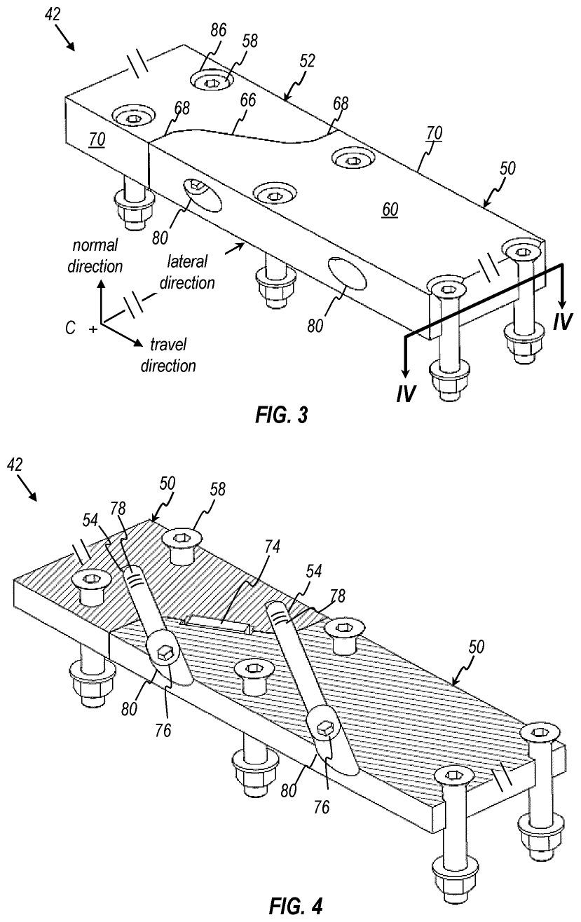

Referring to FIG. 4, the first rail segment 50 and the second rail segment 52 are connected together by the connecting bolts 54. In this embodiment, two connecting bolts 54 are used, but a lesser or greater number of connecting bolts 54 may be used. Each of the connecting bolts 54 extends across the mating end surfaces 62, 64 at a bolt angle that is oblique to the travel direction and the lateral direction. In embodiments, the bolt angle may be between 30 degrees to 60 degrees relative to the travel direction and the lateral direction, and perpendicular or near perpendicular to the intercepted portion of the mating end surfaces 62, 64. Each of the connecting bolts 54 has a connecting bolt head 76 attached to a connecting bolt shaft 78. The connecting bolt head 76 is received in a connecting bolt counterbore hole 80 defined by the first rail segment 50, such that the connecting bolt head 76 applies a bearing force against the first rail segment 50. The connecting bolt counterbore hole 80 avoids the bolt head projecting from the lateral surface 70 of the first rail segment 50. Further, referring to the exploded view of FIG. 7, plugs 56 may be inserted into the connecting bolt counterbore holes 80 so as to cover the connecting bolt heads 76, and form a flush surface with the lateral surface 70. In this manner, the lateral surface 70 may be also be used as a wheel contact surface for a lateral bogie wheel, with minimal or no surface irregularities.

The connecting bolt shaft 78 extends from the connecting bolt counterbore hole 80, through the first rail segment 50, across the mating end surfaces 62, 64, and into the second rail segment 52. An externally threaded portion of the connecting bolt shaft 78 mates with an internally threaded portion of a connecting bolt bore 82 defined by the second rail segment 52. The bearing relationship of the connecting bolt head 76 against the connecting bolt counterbore hole 80, combined with the mating relationship of the externally threaded portion of the connecting bolt shaft 78 with the internally threaded portion of a connecting bolt bore 82 secures the first rail segment 50 to the second rail segment 52. In the illustrated embodiment, the entirety of the connecting bolt 54 is contained within the perimeter of the rail assembly 42 as defined collectively by the first rail segment 50 and the second rail segment 52.

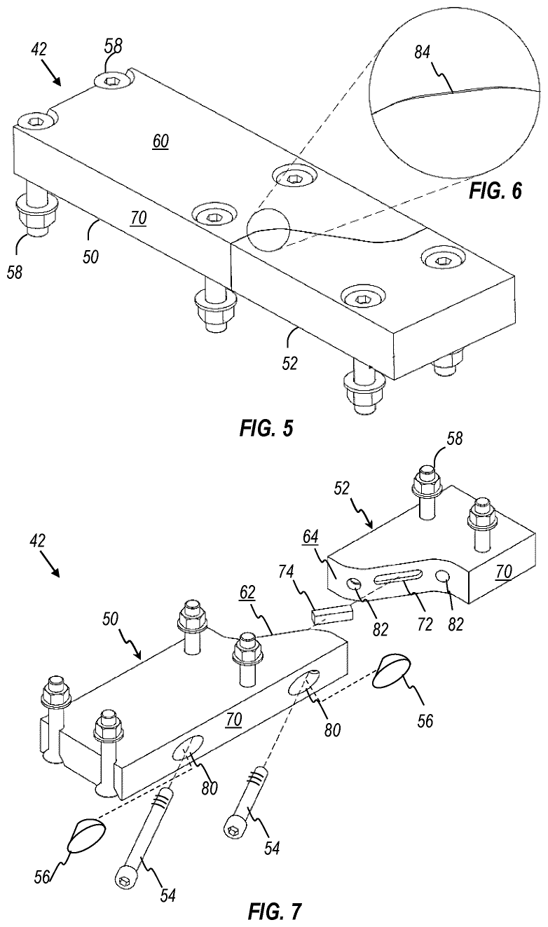

In embodiments, the connecting bolts 54 may be tensioned so as to apply a compressive preload that compresses the first and second rail segments 50, 52 together. Prior to application of this compressive preload, the mating end surfaces 62, 64 may define between them a small gap 84, as shown in FIG. 6. As the connecting bolts 54 are tensioned and apply the compressive preload, the gap 84 is closed until substantially diminished or non-existent, so as to minimize or avoid any geometric irregularity on the normal wheel contact surface 60. The compressive preload also increases the frictional force between the abutting mating end surfaces 62, 64, which may help to resist relative movement between the mating end surfaces 62, 64, and resultant wear of the mating end surfaces 62, 64.

Referring to FIG. 8, mounting bolts 58 are used to connecting the rail segments to an ancillary structure, such as a girder 48. Referring to FIGS. 3 to 7, in this embodiment, the mounting bolts 58 have mounting bolt heads that are received in the mounting bolt counterbore holes 86, and mounting bolt shafts attached to the mounting bolt heads and extending through the rail segment 50, 52 and into the ancillary structure such as the girder 48.

### Bogie.

A purpose of the bogie 44 is to provide one or more wheels that roll against a rail. Therefore, it will be understood that the bogie 44 is for use with a rail having an elongate normal wheel contact surface 60 defining a travel direction for the bogie 44, a lateral direction parallel to the wheel contact surface, and a normal direction perpendicular to the normal wheel contact surface 60, as described above with reference to FIG. 3.

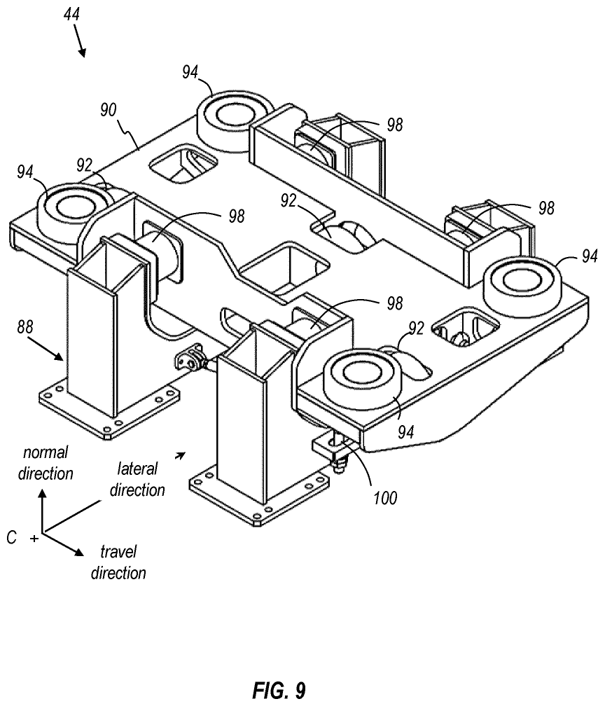

FIGS. 9 to 12 shows views of the bogie 44 of FIG. 2 in isolation. In general, the illustrated embodiment of the bogie 44 includes a support frame 88, a chassis 90, a plurality (e.g. three) of normal wheels 92, a plurality (e.g. four) of lateral wheels 94, one or more (e.g. two) elastomeric normal linear bearings 96, one or more (e.g. four) elastomeric lateral linear bearings 98, one or more (e.g. four) normal link members 100, and one or more travel link member 102. Other than the elastomeric normal linear bearings 96 and elastomeric lateral linear bearings 98, the parts of the bogie 44 may be made of any material having suitable mechanical properties for an intended application, with a non-limiting example being structural strength steel. As used herein, the term “elastomeric” refers to the part (e.g. the normal linear bearings 96 and lateral linear bearings 98) being made, at least in part, of a resilient polymer that is capable of recovering its original shape after being deformed. Non-limiting examples of elastomers that may be suitable for forming the elastomeric normal linear bearings 96 and elastomeric lateral linear bearings 98 include polyurethane, neoprene, styrene butadiene rubber, and the like.

A purpose of the support frame 88 is to provide a member for attaching the bogie 44 to another structure, such as a girder of a building. Referring to the exploded view of FIG. 10, in this embodiment for example, the support frame 88 includes a connected pair of substantially U-shaped members, with mounting plates that may be used to secure the bogie 44 to a girder (not shown). In other embodiments, the support frame 88 may have a different configuration.

A purpose of the chassis 90 is to provide a member on which the normal wheels 92 and the lateral wheels 94 are rotatably mounted. The chassis 90 is movably attached to the support frame 88. In this embodiment for example, the chassis 90 is capable of moving, to a limited extent, relative to the support frame 88 by rotation relative to the support frame 88 about an axis parallel to the normal direction (i.e. a “yaw” rotation), an axis parallel to the travel direction (i.e. a “roll” rotation), and an axis parallel to the lateral direction (i.e. a “pitch” rotation), as well as by translation relative to the support frame 88 in the normal, lateral and travel directions. That is, the chassis 90 may be attached to the support frame 88 in a manner that allows for multiple degrees of freedom of movement of the chassis 90 relative to the support frame 88.

In the illustrated embodiment, the movable attachment of the chassis 90 to the support frame 88 is effected by the link members 100, 102 that loosely tie the chassis 90 to the support frame 88, thus allowing the chassis 90 to “float” with respect to support frame 88. More particularly, the normal link members 100 that allow the chassis 90 to move in the travel, lateral and normal directions under ordinary conditions, but limit movement in the normal direction (e.g. uplift) of the chassis 90 relative to the support frame 88 under extreme loading conditions (e.g. extreme wind or seismic loads). The travel link member 102 is pivotally connected at its ends to the support frame 88 and to the chassis 90 to permit to the aforementioned yaw rotation, roll and pitch rotation of the chassis 90 relative to the support frame 88. The travel link member 102 functions like a tow bar between the support member and the chassis 90. The connections of the link members 100, 102 may be effected by pin connections having suitable tolerances with enclosing apertures that allow for translation and rotation of the chassis 90 relative to the support frame 88. The link members 100, 102 may also be implemented by connections that permit rotation of the chassis 90 relative to the support frame 88, such as a spherical bearing (e.g. a ball joint), a clevis joint, a universal joint, or the like.

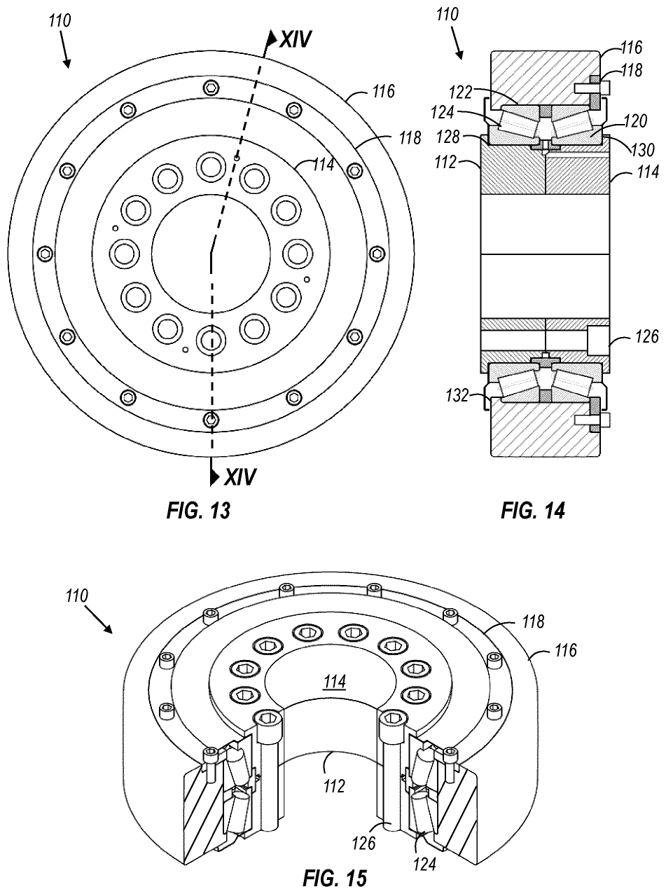

The normal wheels 92 are rotatably mounted to the chassis 90 to roll against the normal wheel contact surface 60 about a rotation axis that extends in the lateral direction. In the illustrated embodiment, the bogie 44 includes three normal wheels 92, with one of the wheels being offset from the other two normal wheels 92 in the lateral direction. In embodiments of the bogie 44 used with a rail comprises a lateral wheel contact surface perpendicular to the lateral direction (i.e. a lateral surface 70 as shown in FIG. 3), the lateral wheels are rotatably mounted to the chassis 90 to roll against the lateral wheel contact surface about a rotation axis that extends in the normal direction. In the illustrated embodiment, the bogie 44 includes a first pair of lateral wheels 94 for rolling against the lateral wheel contact surface of a first rail, and a second pair of lateral wheels 94 for rolling against the lateral wheel contact surface of a second rail, as shown in FIG. 2. In embodiments, the normal wheels 92 and the lateral wheels 94 may be implemented by wheels rotatably supported on axle shafts as known in the art, or by shaft-less wheels of the present disclosure as described below with reference to FIGS. 13 to 15.

In general, one or more elastomeric bearings may be disposed between and in bearing engagement with the support frame 88 and the chassis 90, to limit movement of the chassis 90 relative to the support frame 88, in one or more directions. In the illustrated embodiment, the elastomeric normal linear bearings 96 and elastomeric lateral linear bearings 98 limit movement of the chassis 90 relative to the support frame 88, in the normal directions and the lateral directions, respectively, although not necessarily exclusively in such directions. The elastomeric normal linear bearings 96 are disposed between and in contact with a support frame bearing surface 104 and a chassis bearing surface that are perpendicular to the normal direction. The elastomeric lateral linear bearings 98 are disposed between and in contact with a support frame bearing surface 106 and a chassis bearing surface 108 that are perpendicular to the lateral direction.

On account of their resilient elastic properties, the elastomeric normal linear bearings 96 act as a suspension for the chassis 90, which helps to distribute loads from the normal wheels 92 to the support frame 88, or vice versa. The elastomeric lateral linear bearings 98 provide a “self-steering” effect that limits and corrects for misalignment of the normal wheels 92 and lateral wheels 94 with respect to the rail, to help ensure that they remain in proper aligned contact with the normal wheel contact surface 60 and the lateral wheel contact surface 70, respectively, of the rail. In comparison with machined steel components, elastomeric bearings may also have a lower cost.

### Bogie Wheel.

FIGS. 13 to 15 show views of a wheel 110 of the bogie 44 of FIG. 10, which may be used for the normal wheels 92 or the lateral wheels 94 thereof. In general, the wheel 110 includes a central hub including an inner hub portion 112 and an outer hub portion 114, a tread 116, a clamping ring 118, and a bearing assembly including an inner bearing race 120, an outer bearing race 122, and a plurality tapered roller bearings 124. The parts of the wheel 110 may be made of any material having suitable mechanical properties for an intended application, with a non-limiting example being structural strength steel.

The hub 112, 114 has a generally cylindrical shape that defines an axial direction (i.e. the horizontal direction in the drawing plane of FIG. 14), and a radial direction perpendicular thereto (i.e. the vertical direction in the drawing plane of FIG. 14). The hub 112, 114 is adapted for direct mounting to the bogie chassis 90. In the illustrated embodiment, the hub 112, 114 is adapted for directly mounting to the bogie chassis 90 by defining a plurality of mounting bolt holes for insertion of mounting bolts 126 through the hub and into internally threaded bores defined by the bogie chassis 90. In contrast to prior art approaches requiring precise interference fit of wheels to axle shafts, this approach may allow for more convenient alignment of the hub and wheel with the chassis 90.

In the illustrated embodiment, the hub 112, 114 is a split hub that includes an inner hub portion 112 and an axially outer hub portion 114. Referring to FIG. 14, in the illustrated embodiment, the inner hub portion 112 defines an inner hub portion radial shoulder 128, and the outer hub portion 114 defines an outer hub portion radial shoulder 130. When the mounting bolts 126 extend through the mounting bolt holes defined collectively by the outer hub portion 114 and the inner hub portion 112, the mounting bolts 126 axially compress the outer hub portion 114 against the inner hub portion 112. As a result, the inner hub portion radial shoulder 128 and the outer hub portion radial shoulder 130 clamp against the inner bearing race 120 therebetween to securely attach the inner bearing race 120 to the hub 112, 114.

The tread 116 has a tread outer surface for rolling against the rail. Referring to FIG. 14, in the illustrated embodiment, the tread 116 defines a tread radial shoulder 132. The clamping ring 118 is bolted to the tread 116 to axially compress the outer bearing race 122 of the bearing assembly against the tread radial shoulder 132, to securely attach the outer bearing race 122 to the tread 116.

The bearing assembly includes the aforementioned inner bearing race 120 attached to the hub 112, 114, and outer bearing race 122 attached the tread 116. The bearing assembly also includes a plurality of roller bearings 124 disposed between an distributed along the races 120, 122 to permit rotation of the outer bearing race 122 and the attached tread 116 relative to the inner bearing race 120 and the attached hub 112, 114. Referring to FIG. 14, in the illustrated embodiment, the roller bearings 124 comprise tapered roller bearings 124 that can be set to apply an axial preload (axial interference) with the races 120, 122, to prevent axial shifting of the roller bearings 124 relative to the races 120, 122, as known in the art.

### Inflatable Seal Assembly.

FIGS. 16 and 17 show views of an inflatable seal assembly 46 for sealing between a first member 134 (e.g. a moving girder of a shutter 18 of a telescope enclosure 10 of FIG. 1) and a second member 136 (e.g. a stationary girder of a cap 16 of a telescope enclosure 10 of FIG. 1). In general, the illustrated embodiment of the inflatable seal assembly 46 includes an inflatable bladder 138, a membrane 140, a pair of tension springs 142, a gutter 144, a deflector plate 146, an elastomeric guard member 148.

The inflatable bladder 138 and membrane 140 may be made of flexible materials, provided that the material of the inflatable bladder 138 is sufficiently low in gas permeability to retain a gas such as an air under pressure. In one embodiment, the inflatable bladder 138, the membrane 140, and the elastomeric guard member 148 are made of rubber. More particularly, the rubber may be chlorosulphonated polyethylene synthetic rubber, marketed under the name Hypalon™ (Dupont Performance Elastomers). Hypalon™ is a rubber having good resistance to chemicals, temperature extremes, ultraviolet light, and abrasion, good resistance to adhesive, high strength, and a relatively low coefficient of friction. Further, Hypalon™ can be readily bonded and repaired using commonly-available adhesives, permitting the bladder 138 and the membrane 140 to be conveniently repaired in-situ in its installed state. This readiness for bonding also permits many different customized bladder 138 configurations to be achieved by gluing together multiple panels of various shapes.

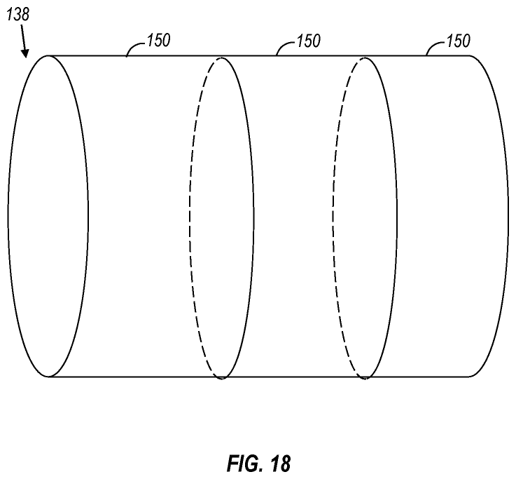

The inflatable bladder 138 can be selectively inflated as shown in FIG. 16 with the use of a pneumatic pump (not shown), and deflated as shown in FIG. 17, optionally with the use of a vacuum pump (not shown) to increase the deflation rate. The bladder 138 may have a single compartment, or be sub-divided by internal partitions into a plurality of bladder compartments 150 as shown in FIG. 18. A multi-compartment bladder 138 may mitigate the impact of a failure of the bladder 138, by limiting the extent of the bladder 138 affected by a leak, and by allowing for quicker detection and repair of a leak.

The membrane 140 provides a protective cover for the bladder 138, thereby protecting the pressurized bladder 138 from ice formation and adhesion of the bladder 138 to mating surfaces. The membrane 140 has a first end that is fixedly attached to the first member 134. The membrane 140 is disposed between the bladder 138 and the second member 136. Accordingly, when the bladder 138 is filled with air from the deflated state (FIG. 18) to the inflated state (FIG. 17), the bladder 138 urges the membrane 140 into contact with the second member 136 or a part attached to the second member 136. In the illustrated embodiment, the membrane 140 is urged into contact with a part attached to the second member 136 in the form of the deflector plate 146. The elastomeric guard member 148 is attached to the edge of the deflector plate 146 to reduce adhesive contact between the membrane 140 and the deflector plate 146.

In the illustrated embodiment, a pair of tension springs 142 are attached to and extend between the membrane 140 second end and to a third member, which is attached to the first member 134. In other embodiments, the tension springs 142 may be attached directly to the first member 134. In the illustrated embodiment, the third member is in the form of a gutter 144, which captures moisture or debris that may pass between the membrane 140 and the deflector plate 146. The tension springs 142 are oriented to bias the membrane second end toward the gutter 144, and thus bias the membrane 140 against the bladder 138. This keeps the membrane 140 in a taut condition, and may assist in increasing the deflation rate of the bladder 138. In other embodiments (not shown), the membrane second end may be unattached.

1. A rail assembly for use with a bogie having a bogie wheel, the rail assembly comprising:
an elongate first rail segment and an elongate second rail segment, wherein the first and second rail segments define complementarily shaped mating end surfaces in abutting relationship with each other, wherein the first and second rail segments collectively define an elongate normal wheel contact surface defining a travel direction for the bogie wheel, a lateral direction parallel to the normal wheel contact surface and perpendicular to the travel direction, and a normal direction perpendicular to the normal wheel contact surface; and
a connecting bolt extending across the mating ends surfaces at a bolt angle that is oblique to the travel direction and the lateral direction, wherein the connecting bolt comprises:
a connecting bolt head received in a connecting bolt counterbore hole defined by the first rail segment; and
a connecting bolt shaft attached to the connecting bolt head and extending into a connecting bolt bore that extends from the connecting bolt counterbore hole, through the first rail segment, and into the second rail segment, wherein an externally threaded portion of the connecting bolt shaft mates with an internally threaded portion of the connecting bolt bore defined by the second rail segment.

2. The rail assembly of claim 1, wherein the connecting bolt is tensioned to apply a compressive preload to compress the first and second rail segments together.

3. The rail assembly of claim 2, wherein the mating end surfaces define a gap between them that is closed by application of the compressive preload.

4. The rail assembly of any one of claims 1 to 3, wherein each of the mating end surfaces comprises an intermediate portion that extends at an end surface angle that is oblique to the travel direction and the lateral direction.

5. The rail assembly of claim 4, wherein each of the mating end surfaces comprises a transition portion that connects the intermediate portion to a lateral surface of the rail segment, wherein the transition portion has a rounded shape in a sectional plane defined by the travel direction and the lateral direction.

6. The rail assembly of any one of claims 1 to 5, wherein the end mating surface has a sigmoid shape in the sectional plane defined by the travel direction and the lateral direction.

7. The rail assembly of any one of claims 1 to 6, further comprising a key member, wherein the mating end surfaces collectively define a pocket that retains the key member to interfere with relative movement between the first and second rail segments.

8. The rail assembly of anyone of claims 1 to 7, further comprising a plug that is received in the connecting bolt counterbore hole to cover the connecting bolt head, wherein the plug is flush with the lateral surface.

9. The rail assembly of any one of claims 1 to 8, further comprising a mounting bolt extending in the normal direction, and comprising a mounting bolt head received in a mounting bolt counterbore hole defined by either the first rail segment or the second rail segment, and a mounting bolt shaft attached to the mounting bolt head and extending through the rail segment and into an ancillary structure.

10. The rail assembly of any one of claims 1 to 9, wherein the wheel contact surface is arcuate.

11. A bogie for use with a rail comprising an elongate normal wheel contact surface defining a travel direction for the bogie, a lateral direction parallel to the normal wheel contact surface and perpendicular to the travel direction, and a normal direction perpendicular to the normal wheel contact surface, the bogie comprising:
a support frame;
a chassis movably attached to the support frame;
at least one normal wheel rotatably mounted to the chassis to roll against the normal wheel contact surface about a rotation axis that extends in the lateral direction; and
at least one elastomeric bearing disposed between and in bearing engagement with the support frame and the chassis, to limit movement of the chassis relative to the support frame.

12. The bogie of claim 11, wherein the chassis is movably attached to the support frame to permit the chassis to rotate relative to the support frame, about an axis parallel to the normal direction.

13. The bogie of any one of claims 11 to 12, wherein the chassis is movably attached to the support frame to permit the chassis to rotate relative to the support frame, about an axis parallel to the travel direction.

14. The bogie of any one of claims 11 to 13, wherein the chassis is movably attached to the support frame to permit the chassis to rotate relative to the support frame, about an axis parallel to the lateral direction.

15. The bogie of any one of claims 11 to 14, wherein the chassis is movably attached to the support frame to permit the chassis to rotate relative to the support frame, about an axis parallel to the travel direction.

16. The bogie of any one of claims 11 to 15, wherein the chassis is movably attached to the support frame to permit the chassis to translate relative to support frame, in the normal direction.

17. The bogie of any one of claims 11 to 16, wherein the chassis is movably attached to the support frame to permit the chassis to translate relative to support frame, in the lateral direction.

18. The bogie of any one of claims 11 to 17, wherein the at least one elastomeric bearing comprises an elastomeric lateral linear bearing, disposed between and in bearing engagement with the support frame and the chassis, to limit movement of the chassis relative to the support frame in the lateral direction.

19. The bogie of claim 18, wherein the support frame defines a support frame bearing surface that is perpendicular to the lateral direction, wherein the chassis defines a chassis bearing surface that is perpendicular to the lateral direction, and wherein the elastomeric lateral linear bearing is disposed between and in bearing engagement with the support frame and the chassis by contact with the support frame bearing surface and the chassis bearing surface that are perpendicular to the lateral direction.

20. The bogie of any one of claims 11 to 19, wherein the at least one elastomeric bearing comprises an elastomeric normal linear bearing, disposed between and in bearing engagement with the support frame and the chassis, to limit movement of the chassis relative to the support frame in the normal direction.

21. The bogie of claim 20, wherein the support frame defines a support frame bearing surface that is perpendicular to the normal direction, wherein the chassis defines a chassis bearing surface that is perpendicular to the normal direction, and wherein the elastomeric normal linear bearing is disposed between and in bearing engagement with the support frame and the chassis by contact with the support frame bearing surface and the chassis bearing surface that are perpendicular to the normal direction.

22. The bogie of any one of claims 11 to 21, wherein the at least one normal wheel comprises at least three normal wheels, wherein one of the normal wheels is offset from the other two normal wheels in the lateral direction.

23. The bogie of any one of claims 11 to 22, for use with the rail comprising a lateral wheel contact surface perpendicular to the lateral direction, and wherein the bogie further comprises at least one lateral wheel rotatably mounted to the chassis to roll against the lateral wheel contact surface about a rotation axis that extends in the normal direction.

24. A bogie wheel for mounting to a bogie chassis and rolling against a rail, the bogie wheel comprising:
a central hub defining an axial direction, and adapted for direct mounting to the bogie chassis;
a tread comprising a tread outer surface for rolling against the rail; and
a bearing assembly comprising an inner bearing race attached to the hub, an outer bearing race attached to the tread, and a plurality of roller bearings disposed between and distributed along the races to permit rotation of the outer bearing race and the attached tread relative to the inner bearing race and the attached hub.

25. The bogie wheel of claim 24, wherein the hub is adapted for directly mounting to the bogie chassis by defining a plurality of mounting bolt holes.

26. The bogie wheel of any one of claims 24 to 25, wherein the roller bearings comprise tapered roller bearings.

27. The bogie wheel of any one of claims 24 to 26, wherein the hub is a split hub comprising an inner hub portion and an axially outer hub portion, wherein the inner hub portion defines an inner hub portion radial shoulder, and the outer hub portion defines an outer hub portion radial shoulder, wherein a mounting bolt extends through a mounting hole defined collectively by the outer hub portion and the inner hub portion to axially compress the outer hub portion against the inner hub portion, whereby the inner hub portion radial shoulder and the outer hub portion radial shoulder clamp against the inner bearing race to attach the inner bearing race to the hub.

28. The bogie wheel of any one of claims 24 to 27, wherein the tread defines a tread radial shoulder and wherein the tread is attached to the outer bearing race by a clamping ring bolted to the tread and axially compressing the outer bearing race against the tread radial shoulder.

29. An inflatable seal assembly for sealing between a first member and a second member, the inflatable seal assembly comprising:
an inflatable bladder; and
a membrane extending from a membrane first end to a membrane second end, wherein the membrane first end is fixedly attached to the first member, wherein the membrane is disposed between the bladder and the second member such that, in use, inflation of the bladder urges the membrane into contact with the second member or a part to the second member.

30. The inflatable seal assembly of claim 29, further comprising a tension spring attached to and extending between the membrane second end and to the first member or to a third member attached to the member, wherein the tension spring is oriented to bias the membrane against the bladder.

31. The inflatable seal assembly of claim 30, further comprising the third member.

32. The inflatable seal assembly of claim 31, wherein the third member comprises a gutter.

33. The inflatable seal assembly of any one of claims 29 to 32, further comprising the part attached to the second member, wherein the part attached to the second member comprises an elastomeric guard member.

34. The inflatable seal assembly of any one of claims 29 to 33, wherein the membrane is made of a rubber.

35. The inflatable seal assembly of claim 34, wherein the rubber comprises chlorosulphonated polyethylene synthetic rubber.

36. The inflatable seal assembly of any one of claims 29 to 35, wherein the bladder comprises multiple compartments.
